(19) United States
(12) Patent Application Publication
(10) Pub. No.: US 2019/0030639 A1
(43) Pub. Date: Jan. 31, 2019

(54) ULTRASONIC WELDING APPARATUS

(71) Applicant: SCHUNK SONOSYSTEMS GMBH, Wettenberg (DE)

(72) Inventors: Reiner Schmidt, Lollar (DE); Stefan Müller, Wetzlar (DE); Waldemar Werner, Reiskirchen (DE); Peter Wagner, Wettenberg (DE); Rainer Wagenbach, Merenberg (DE); Manuel Fey, Mittenaar (DE)

(21) Appl. No.: 15/772,181

(22) PCT Filed: Oct. 31, 2016
(86) PCT No.: PCT/EP2016/076232

§ 371 Date: Aug. 23, 2018

(30) Foreign Application Priority Data
Nov. 9, 2015 (DE) 10 2015 222 013.3

(51) Int. Cl. B23K 20/10

(52) U.S. Cl. CPC B23K 20/10; B23K 2101/38

(57) ABSTRACT

The invention relates to an ultrasonic welding apparatus (10) for welding rod-shaped electric conductors (17, 28, 29) which are provided with an insulating outer sheath and have bare regions (33) free of the sheath, comprising a compression space arrangement (41) having a compression space for receiving bare regions to be connected to each other, and a positioning device (42) for positioning the bare regions (33) relative to each other, the positioning device having two stop elements (46, 47) which each have a stop surface (48, 49) for axially positioning a bare region (33) in such a manner that the bare regions (33) overlap with an overlap length l in order for a weld node to be formed, wherein the positioning device (42) is remote from the compression space arrangement (41) and is provided with a transferring device (43) which has a receiving device (52) for fixedly receiving, outside of the compression space (18), the conductors (17, 28, 29) axially positioned by means of the positioning device (42), and the transferring device (43) serves to transfer the conductors (17, 28, 29) fixed in a receiving position in the receiving device (52) into the welding position within the compression space.

The present invention relates to an ultrasonic welding apparatus for welding rod-shaped electric conductors which are provided with an outer insulating sheath and have bare regions free of the sheath, comprising a compression space for receiving the bare regions to be connected to each other, and a positioning device for positioning the bare regions relative to each other, the positioning device having two stop elements which each have a stop surface for axially positioning a bare region in such a manner that the bare regions overlap with an overlap length l in order for a weld node to be formed.

From DE 10 2013 222 938 B3, a device of the kind mentioned above is known, in which the positioning device is formed on the compression space, positioning of the bare regions of the conductor between which a contact is to be formed thus taking place within the compression space. Moreover, in the known positioning device, the bare regions are positioned indirectly because the stop elements used to form the positioning device have stop edges against which an axial sheath end surface of the conductors, which delimits the bare region from the insulating sheath, is positioned.

Since the bare regions are positioned in the compression space, positioning takes place in a confined space. Moreover, the positioning contact between the conductors and the stop elements happens solely in the area of the sheathing insulation, which has only a small wall thickness, which means that exact positioning of the conductors requires corresponding dexterity of the operator.

The object of the present invention is to propose an ultrasonic apparatus for welding electrical conductors that is provided with a positioning device that simplifies exact positioning of the conductors in the compression space.

To attain said object, the device according to the invention has the features of claim 1.

According to the invention, the positioning device is remote from the compression space and is provided with a transferring device which has a receiving device for fixedly receiving, outside of the compression space, the bare regions axially positioned by means of the positioning device, and the transferring device serves to transfer the conductors fixed in a receiving position in the receiving device into the welding position in the compression space.

The device according to the invention allows handling for positioning the electrical conductors outside of the compression space without the confined space within the compression space making handling more difficult.

According to an advantageous embodiment, the stop surfaces of the stop elements are disposed at a positioning distance from each other in such a manner that a clearance is formed between end cross-sections of the bare regions fixed in the receiving device, and the transferring device is provided with an axial advancing device which serves to combine an axial advancing movement of the conductors with a transferring movement for transferring the conductors into the compression space in such a manner that in addition to the transferring movement of the conductors into the compression space, an axial advancing movement of the conductors is performed by means of the advancing device so as to make the bare regions of the conductors overlap.

This special embodiment provides the possibility of positioning the conductors outside of the compression space in a particularly simple and safe manner because the end cross-sections of the conductors can be positioned against the stop elements outside of the compression space, which eliminates the risk that positioning may hardly be possible without significant skill in handling the conductor ends because a contact surface between the stop elements and the conductors is too small.

The combination of the transferring movement and the advancing movement results in the overlap of the bare regions required for producing the weld node in the compression space without an operator's intervention in the axial positioning process. Instead, positioning in the compression space takes place solely because of the performance of the transferring movement by means of the transferring device.

While it is generally possible for the advancing movement and the transferring movement to be performed one after the other, it is particularly advantageous if the advancing device is configured in such a manner that the axial advancing movement happens during the transferring movement of the conductors into the compression space, which allows the advancing device to take up particularly little space. If the transferring device has two swivel arms, each of which is assigned to at least one conductor and has a releasable clamping device for forming the receiving device at its free end and is disposed on a swivel pin of a swivel bearing at its other end, the swivel pin being formed as a threaded spindle guided in a spindle nut so as to form the advancing device, an overlap between the bare regions between which a contact is to be formed can be brought about in a particularly simple manner by a simple swiveling movement of the swivel arms starting from a position in which the bare regions are spaced apart from each other outside of the connecting space.

Preferably, the threaded spindles are formed with threads that run in opposite directions, wherein it is particularly preferred if the threaded spindles have steep threads.

Preferably, the swiveling movement is performed manually so as to avoid the disposition of additional actuators or the like in the area of the compression space.

According to a particularly preferred embodiment, the clamping device is disposed on the swivel arms in such a manner that when the swivel arms are in the receiving position for receiving the conductors in the clamping device, a clamp opening faces upward, which allows the operator to comfortably place the conductors in the clamping device from above so as to position the conductors outside of the compression space, followed by actuation of the clamping device to fix the conductors and, after swiveling of the swivel arms, the clamping can be loosened and the conductors are released from the clamping device so as to arrange the conductors in the compression space.

This leads to the particular advantage that the conductors are no longer held in the clamping device during the ultrasound treatment of the bare regions for forming the weld node, adverse effects of the ultrasound treatment on the conductor surface, in particular on the insulation of the conductors, thus being precluded.

Hereinafter, a preferred embodiment of the ultrasonic welding apparatus is explained in more detail with reference to the drawing.

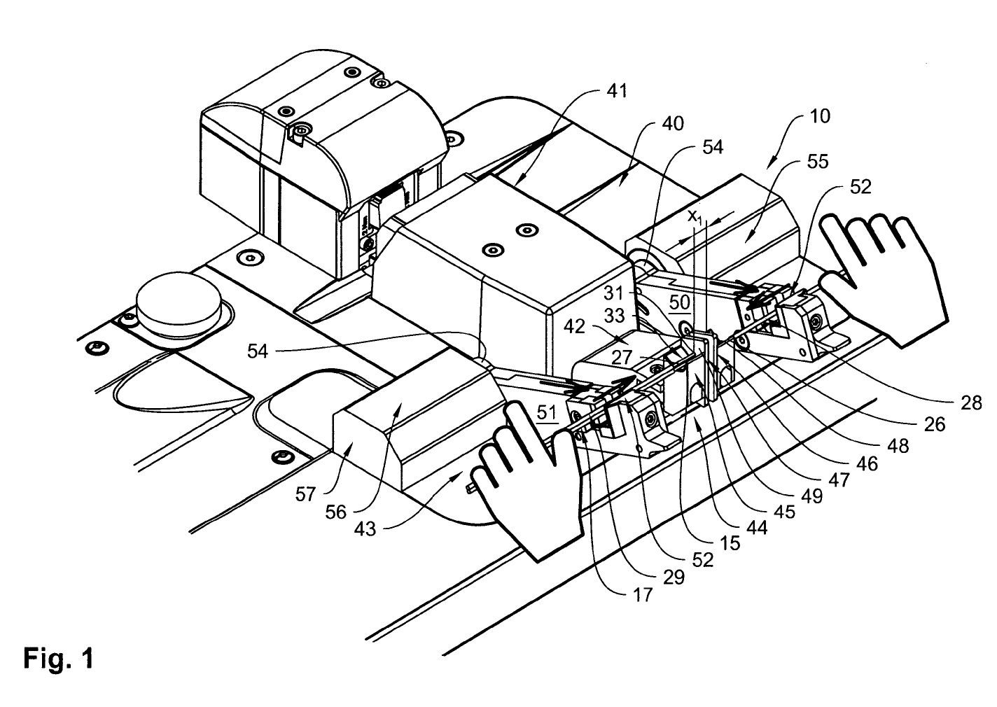

FIG. 1 shows a top view of the work desk of an ultrasonic welding apparatus comprising a compression space arrangement and a transferring device in the receiving position;

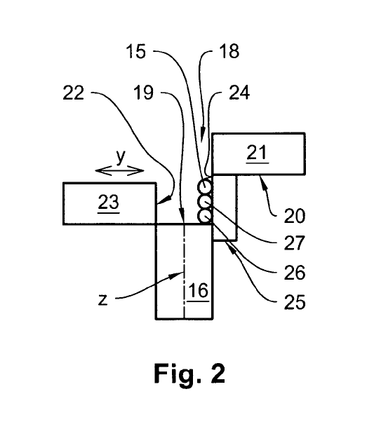

FIG. 2 shows a compression space formed in the compression space arrangement illustrated in FIG. 1 with two conductors arranged in the welding position;

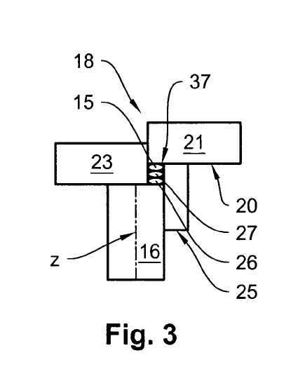

FIG. 3 shows the compression space illustrated in FIG. 1 in the closed position;

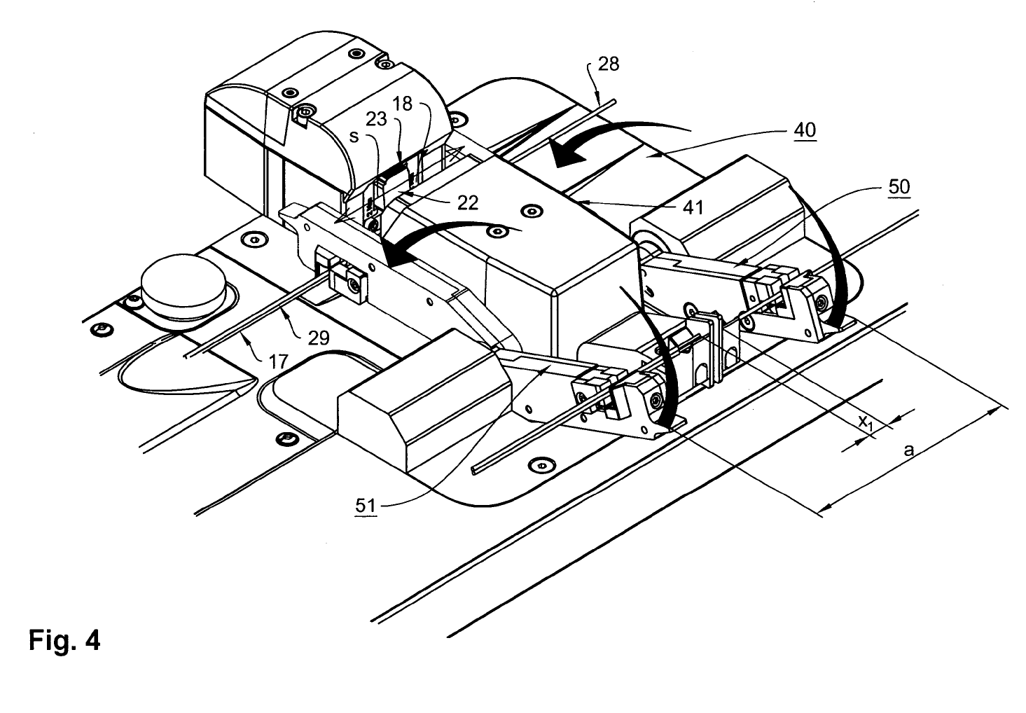

FIG. 4 shows a transfer process from a receiving position into a welding position;

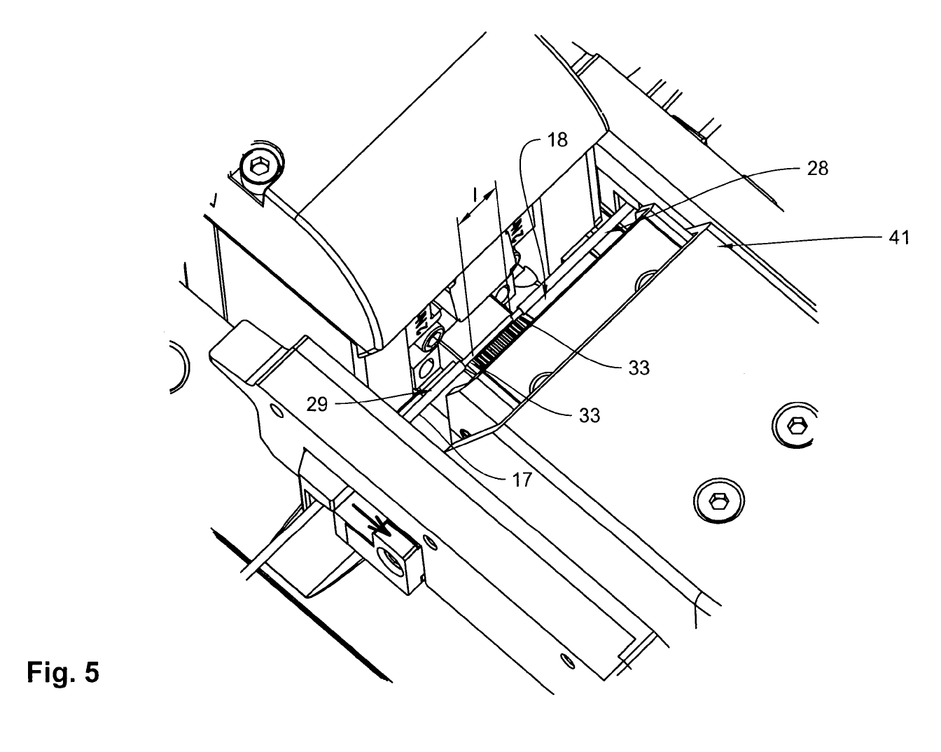

FIG. 5 shows the conductors arranged in the welding position in the compression space.

FIG. 1 shows a work desk 40 of an ultrasonic welding apparatus 10 comprising a compression space arrangement 41 and a positioning device 42 which is remote from the compression space arrangement 41.

As shown in FIG. 1, the positioning device 42 has a stop surface arrangement 44 having a stop reception 45 for disposing stop elements 46, 47 in such a manner that they can be axially displaced relative to each other in such a manner that stop surfaces 48, 49 of the stop elements 46, 47 can be locked at a defined axial distance x₁ from each other. As shown in FIG. 1, in a receiving position, the positioning device 42 allows an operator to place connecting regions 17, 26, 27 of conductors 17, 28, 29 in receiving devices 52 in such a manner that the end cross-sections 31 of stripped bare regions 33 of the conductors 17, 28, 29, which form the connecting regions 15, 26, 27, are positioned against the stop surfaces 48, 49 with a clearance x₁ between them.

The substantial elements of a compression space 18 which is formed in the compression space arrangement 41 are illustrated in FIGS. 2 and 3. In a first axial direction (z-axis), the compression space 18 is limited at two opposite sides by an active surface 19 of the sonotrode 16 transmitting ultrasonic vibrations and by a counter surface 20 of a counter electrode 21 movable in a second axial direction (y-axis). In the second axial direction, which is represented by the y-axis in FIG. 2, the compression space 18 is limited at two opposite sides by a boundary surface 22 of a slider element 23 moveable in the direction of the y-axis and by a boundary surface 24 of a boundary element 25 displaceable in the direction of the z-axis like the counter electrode 21.

In the compression space 18 illustrated in FIG. 2, the three connecting portions 15, 26, 27 of the conductors 17, 28, 29 illustrated in FIG. 1 are stacked on top of each other and are located on the active surface 19 of the sonotrode 16, FIG. 2 showing the connecting regions 15, 26, 27 disposed in a welding position immediately after having been placed in the opened compression space 18.

FIG. 3 shows the compression space 18 in the closed configuration, in which the components limiting the compression space 18, i.e. the sonotrode 16, the counter electrode 21, the slider element 23 and the boundary element 25, are moved against each other in such a manner that the compression space 18 now reduced in volume forms a mold 37 which, when the connecting regions 15, 26, 27 of the conductors 17, 28, 29 are subjected to mechanical vibrations of the sonotrode 16 in a friction welding process, allows the connecting regions 15, 26, 27 to be compressed and connected to each other so as to form a weld node.

As FIG. 1 further shows, the positioning device 42 is provided with a transferring device 43 which has two swivel arms 50, 51, each of which is provided with a receiving device 52, the receiving device 52 of swivel arm 50 receiving conductor 28 and the receiving device 52 of swivel arm 51 receiving conductors 17 and 29. The receiving devices 52 are provided with releasable clamping devices 53 for fixing the conductors 17, 28, 29. Once the end-cross sections 31 of the bare regions 33 of the conductors 17, 28, 29 have been positioned against the stop surfaces 48, 49, the clamping devices 53 are closed, the conductors 28, 29 thus being arranged parallel to each other in the axial direction and a corresponding parallel arrangement of the conductors 17, 28, 29 thus being ensured in the welding position as well.

Each swivel arm 50, 51 is disposed on a swivel pin 54 of a swivel bearing 55, the swivel pins 54 being formed as threaded spindles having threads running in opposite directions, each threaded spindle being guided in a spindle nut 56, the swivel bearings 55 thus forming an advancing device 57 in such a manner that, as illustrated in FIG. 4, which shows the swivel arms 50, 51 both in the receiving position (solid line) and in the welding position (dashed line), the swivel arms 50, 51 change their axial distance from each other when they are being swiveled about the swivel bearings 55 from the receiving position remote from the compression space arrangement 41 into the welding position adjacent to the compression space arrangement 41 in such a manner that the receiving distance a in the receiving position is reduced to the welding distance s in the welding position.

As a result of the transferring movement of the swivel arms 50, 51 explained above, the conductors 17, 28, 29 which, in the receiving position, are placed into the receiving device 52 by an operator and the end-cross-sections 31 of whose bare regions 33 are positioned against the stop surfaces 48, 49 have a clearance x₁ between them when in the receiving position as shown in FIG. 1, and the bare regions 33 overlap each other with an overlap length l when in the welding position, in which the swivel arms 50, 51 have only the reduced distance s from each other, as shown in FIG. 5.

As shown in FIG. 4, the clamping devices 57 are opened once the swivel arms 50, 51 have been transferred into the welding position, which means that no holding forces act on the conductors 17, 28, 29 during ultrasonic welding.

1. An ultrasonic welding apparatus (10) for welding rod-shaped electric conductors (17, 28, 29) which are provided with an insulating outer sheath and have bare regions (33) free of the sheath, comprising a compression space arrangement (41) having a compression space (18) for receiving bare regions to be connected to each other, and a positioning device (42) for positioning the bare regions (33) relative to each other, the positioning device having two stop elements (46, 47) which each have a stop surface (48, 49) for axially positioning a bare region (33) in such a manner that the bare regions (33) overlap with an overlap length l in order for a weld node to be formed, characterized in that the positioning device (42) is remote from the compression space arrangement (41) and is provided with a transferring device (43) which has a receiving device (52) for fixedly receiving, outside of the compression space (18), the conductors (17, 28, 29) axially positioned by means of the positioning device (42), and the transferring device (43) serves to transfer the conductors (17, 28, 29) fixed in a receiving position in the receiving device (52) into the welding position within the compression space (18).

2. The device according to claim 1, characterized in that, the stop surfaces (48, 49) of the stop elements (46, 47) are disposed at a positioning distance from each other in such a manner that a clearance x₁ is formed between end cross-sections (31) of the bare regions (33) of the conductors (17, 28, 29) fixed in the receiving device (52), and the transferring device (43) is provided with an axial advancing device (57) which serves to combine an axial advancing movement of the conductors (28, 29) with a transferring movement for transferring the conductors (17, 28, 29) into the compression space (18) in such a manner that in addition to the transferring movement of the conductors (17, 28, 29) into the compression space (18), an axial advancing movement of the conductors is performed by the advancing device (57) so as to make the bare regions (31) of the conductors (17, 28, 29) overlap.

3. The device according to claim 2, characterized in that, the advancing device (57) is configured in such a manner that the axial advancing movement takes place during the transferring movement of the conductors (17, 28, 29) into the compression space (18).

4. The device according to claim 3, characterized in that, the transferring device (43) has two swivel arms (50, 51), each of which is assigned to at least one conductor (17, 28, 29) and has a releasable clamping device (53) at its free end for forming the receiving device (52) and is disposed on a swivel pin (54) of a swivel bearing (55) at its other end, the swivel pin (54) being formed as a threaded spindle guided in a spindle nut (56) so as to form the advancing device (57).

5. The device according to claim 4, characterized in that, the threaded spindles are formed with threads running in opposite directions.

6. The device according to claim 4, characterized in that, the clamping device (53) is disposed on the swivel arms (50, 51) in such a manner that a clamp opening faces upward when the swivel arms (50, 51) are in a receiving position for receiving the conductors (28, 29) in the clamping device (53).
